(19) United States
(12) Patent Application Publication
(10) Pub. No.: US 2005/0217139 A1
(43) Pub. Date: Oct. 6, 2005

(54) Clothes dryer

(75) Inventor: Kyung-Seop Hong, Yeonsu-Gu (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/017,723

(22) Filed: Dec. 22, 2004

(30) Foreign Application Priority Data
Apr. 6, 2004 (KR) 23492/2004

(51) Int. Cl. F26B 11/02

(52) U.S. Cl. 34/604; 34/605

(57) ABSTRACT

Disclosed is a clothes dryer comprising a drum rotatably installed in a cabinet; a suction duct having a suction port for providing air inside the cabinet into the drum, and connected to the drum at one side of the drum; a suction fan arranged in the suction duct, for sucking air inside the cabinet through the suction port; and a suction guide extendingly installed from an outer circumferential surface of the suction port, for guiding air introduced to the suction duct. Thus, as the suction guide is installed at the suction port, it can be achieved to restrain a noise generation due to an air flow, to facilitate to cool a motor and to enhance an energy efficiency.

### BACKGROUND OF THE INVENTION

1. Field of the Invention

The present invention relates to a clothes dryer, and more particularly, to a clothes dryer having a suction guide and capable of restraining noise generation due to an air flow, facilitating to cool a motor, and enhancing an energy efficiency.

2. Description of the Conventional Art

FIG. 1 is a section view showing a clothes dryer in accordance with the conventional art, FIG. 2 is a perspective view showing a suction opening of FIG. 1, and FIG. 3 is an enlargement view of a main part of FIG. 1. As shown, the conventional clothes dryer comprises: a cabinet 11 having an accommodation space therein; a drum 21 rotatably installed in the cabinet 11; a suction duct 31 arranged at one side of the drum 21 for sucking air inside the cabinet 11 and thereby supplying the air into the drum 21; a heater 35 installed in the suction duct 31 and heating air; and a driving motor 41 for rotating the drum 21.

A door 13 through which laundry is introduced/taken into/out of the cabinet 11 is provided at a front surface of the cabinet 11, and an inlet 15 for introducing external air is formed at a rear surface of the cabinet 11. An exhaust port 22 for exhausting air inside the drum 21 is formed at a lower portion of a front surface of the drum 21, and one end of an exhaust duct 25 is connected to the exhaust port 22 so as to exhaust air outside the cabinet 11.

A suction duct 31 for sucking air inside the cabinet 11 and thereby introducing into the drum 21 is installed at a rear surface of the drum 21 along an up-down direction of the drum 21, and a suction port 32 for sucking air inside the cabinet 11 is formed at a lower portion of the suction duct 31. A bell mouth 33 having a shape of an entrance of a bell is formed at a sectional surface of the suction port 32 in order to smoothly flow air at the time of an air suction.

A cylindrical suction fan 37 for sucking air through the suction port 32 is arranged in the suction duct 31, and a heater 35 for heating air in a flow direction of air is installed at an upper side of the suction fan 37.

A double pulley system 50 is mounted at an end of one side of the driving motor 41 installed at one side of the drum 21 and having a rotation shaft 43 extended to both sides for a rotation-driving of the drum 21. That is, a first driven pulley 44 and a second driven pulley 46 concentrically coupled to each other are rotatably installed at one side of the rotation shaft 43, and a driving pulley 45 is rotatably coupled to the end of one side of the rotation shaft 43 as a unit. A first belt 47 rotatably coupled to the first driven pulley 44 is rotatably coupled to the driving pulley 45, and a second belt 49 coupled to the periphery of the drum 21 is rotatably coupled to the second driven pulley 46. The suction fan 37 rotatably arranged in the suction duct 31 is rotatably coupled to the end of another side of the rotation shaft 43 of the driving motor 41.

An operation of the conventional clothes dryer will be explained as follows.

When a power source is supplied to the driving motor 41, the rotation shaft 43 is rotated. At this time, the suction fan 37 connected to one end of the rotation shaft 43 and the drum 21 connected to another end of the rotation shaft 43 are respectively rotated. As the suction fan 37 is rotated, air is sucked into the suction duct 31 and then is heated by the heater 35 thus to be dried. Then, the dried air is introduced into the drum 21. The air containing moisture by being in contact with laundry to be dried is exhausted outside the drum 21 through the exhaust port 22, and is exhausted outside the cabinet 11 through the exhaust duct 25 connected to the exhaust port 22.

However, in the conventional clothes dryer, as shown in FIG. 3, a flow of peripheral air of the bell mouth 33 is drastically changed when the suction fan is rotated, and thereby a suction efficiency of air is degraded even if the bell mouth is provided at a circumferential surface of the suction port in order to smoothly guide an air flow at the time of sucking air. Also, noise is generated at the periphery of the suction port.

Additionally, the driving motor for rotating the suction fan and the drum is overheated thereby to degrade the efficiency of the driving motor.

### SUMMARY OF THE INVENTION

Therefore, an object of the present invention is to provide a clothes dryer having a suction guide and capable of restraining noise generation due to an air flow, facilitating to cool a motor, and enhancing an energy efficiency.

To achieve these and other advantages and in accordance with the purpose of the present invention, as embodied and broadly described herein, there is provided a clothes dryer comprising: a drum rotatably installed in a cabinet; a suction duct having a suction port for providing air inside the cabinet into the drum, and connected to the drum at one side of the drum; a suction fan arranged in the suction duct, for sucking air inside the cabinet through the suction port; and a suction guide extendingly installed from an outer circumferential surface of the suction port, for guiding air introduced to the suction duct.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings:

FIG. 1 is a section view showing a clothes dryer in accordance with the conventional art;

FIG. 2 is a perspective view showing a suction opening of FIG. 1;

FIG. 3 is an enlargement view of a main part of FIG. 1;

FIG. 4 is a section view showing a clothes dryer according to one embodiment of the present invention;

FIG. 5 is a perspective view showing a suction guide of FIG. 4;

FIG. 6 is an enlargement view of a main part of FIG. 4;

FIG. 7 is a section view showing a clothes dryer according to another embodiment of the present invention;

FIG. 8 is an enlargement view of a main part of FIG. 7; and

FIG. 9 is a perspective view showing a suction guide of FIG. 8.

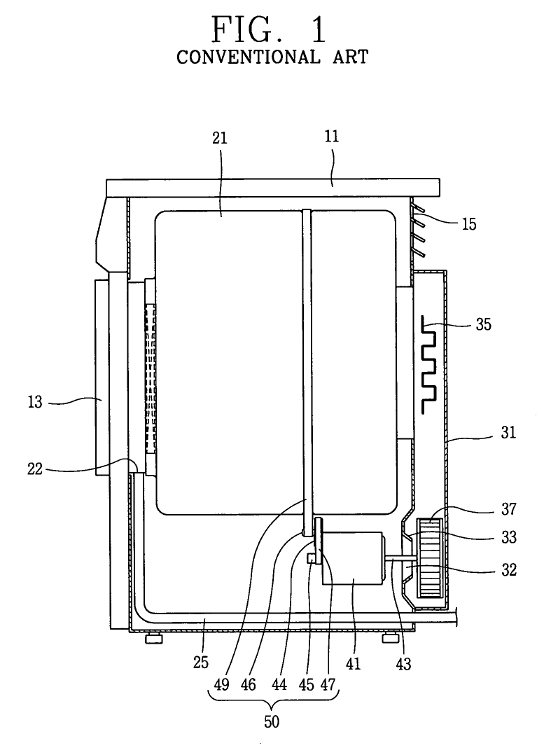

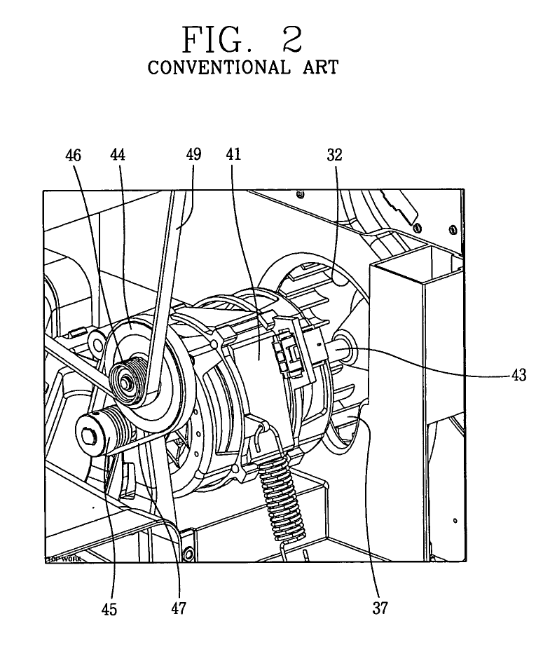

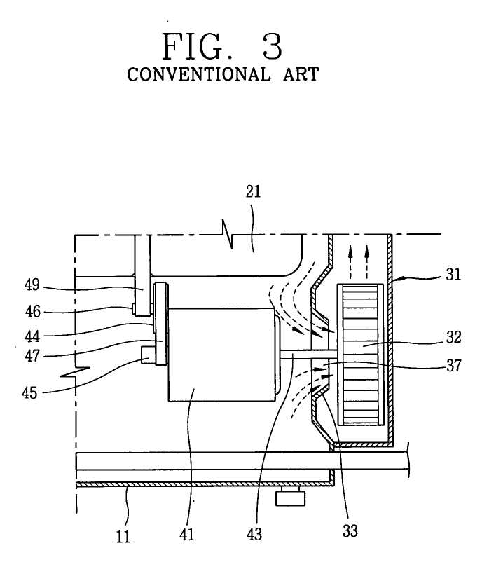

### DETAILED DESCRIPTION OF THE PREFERRED EMBODIMENTS

Reference will now be made in detail to the preferred embodiments of the present invention, examples of which are illustrated in the accompanying drawings.

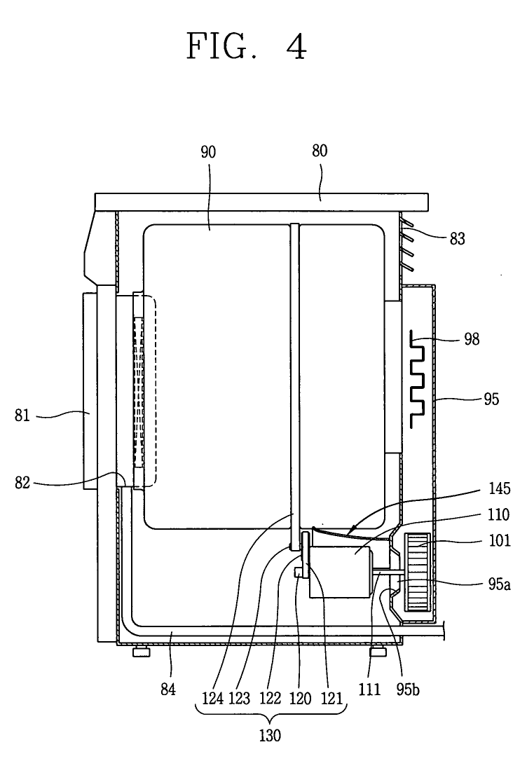

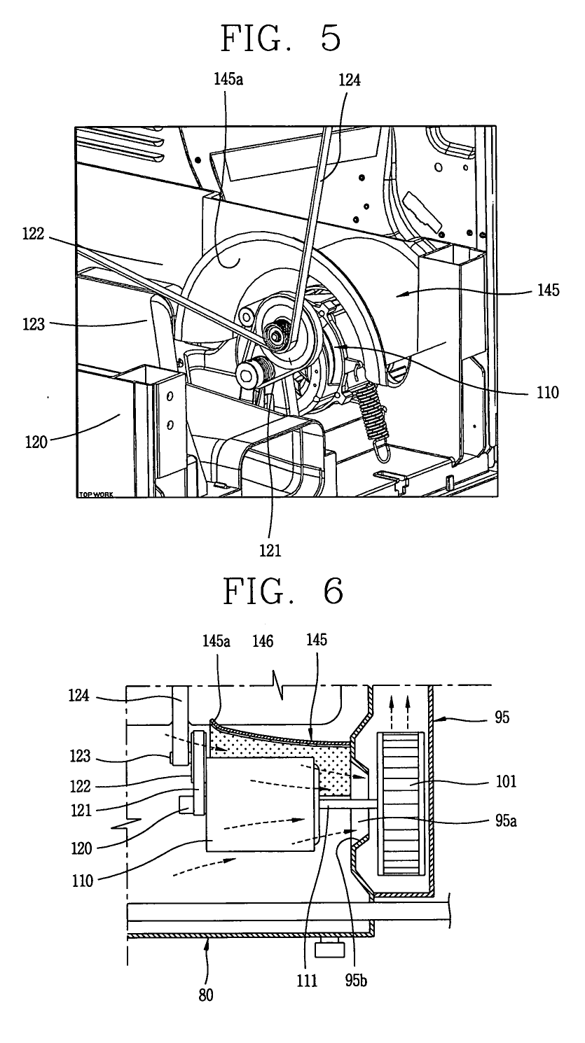

FIG. 4 is a section view showing a clothes dryer according to one embodiment of the present invention, FIG. 5 is a perspective view showing a suction guide of FIG. 4, and FIG. 6 is an enlargement view of a main part of FIG. 4.

As shown, a clothes dryer according to one embodiment of the present invention comprises: a cabinet 80 having an accommodation space therein; a drum 90 rotatably installed in the cabinet 80; a suction duct 95 having a suction port 95a for providing air inside the cabinet 80 into the drum 90, and connected to the drum 90 at one side of the drum 90; a suction fan 101 arranged in the suction duct 95, for sucking air inside the cabinet 80 through the suction port 95a; and a suction guide 145 extendingly formed from an outer circumferential surface of the suction port 95a, for guiding air introduced to the suction duct 95 through the suction port 95a.

A door 82 through which laundry is introduced/taken into/out of the cabinet 80 is provided at a front surface of the cabinet 80, and an inlet 83 for introducing external air is formed at a rear surface of the cabinet 80.

An exhaust port 82 for exhausting air inside the drum 90 is formed at one side of a front surface of the drum 90, and one side of an exhaust duct 84 is connected to the exhaust port 82 so as to exhaust air inside the drum 90 outside the cabinet 80.

A heater 98 for heating introduced air is arranged at an upper side of the suction fan 101 in the suction duct 95 along a flow direction of air.

The suction fan 101 is formed as a cylindrical shape, and an axial fan is used as the suction fan.

The suction port 95a of the suction duct 101 is provided with a flange portion 95b having a shape of a bell mouth in order to smoothly flow air introduced into the suction duct 95a.

A driving motor 110 having a rotation shaft 111 extended to both sides in order to rotate the suction fan 101 and the drum 90 is installed at an outer side of the suction port 95a. The suction fan 101 is rotatably coupled to one end of the rotation shaft 111 of the driving motor 110, and a double pulley system 130 for rotating the drum 90 is mounted at another end of the rotation shaft 111 of the driving motor 110.

The double pulley system 130 is composed of: a driving pulley 120 mounted at one end of the rotation shaft 111 of the driving motor 110; first and second driven pulleys 122 and 123 installed at one side of the driving pulley 120; a first belt 121 for connecting the driving pulley 120 and the first driven pulley 122; and a second belt 124 for connecting the second driven pulley 123 and the drum 90.

The driving motor 110 is positioned inside an inner circumferential surface of the suction guide 145, and the suction guide 145 is formed as a circular arc shape in order to cover a part of the circumference of the driving motor 110.

A construction and a shape of the suction guide 145 according to one embodiment of the present invention will be explained in more detail as follows.

One side of the suction guide 145 is fixedly installed at an outer circumferential surface of the suction port 95a, and another end of the suction guide 145, that is, an inlet of the suction guide 145 is opened to introduce air into the suction port of the suction duct.

The suction guide 145 is preferably extended as a curved surface in order to gradually reduce an air flowing area from the inlet of the suction guide 145 towards the suction port 95a of the suction duct 95.

The inlet of the suction guide 145 is preferably provided with a flange portion 145a having a shape of a bell mouth such as an entrance of a bell in order to smoothly introduce air into the suction guide 145.

The shape of the suction guide 145 according to one embodiment of the present invention can be variously modified according to a design with consideration of a flow of air passing through the inside of the suction guide 145.

That is, the suction guide 145 can be extendingly formed with an inclination of a certain angle on the basis of the rotation shaft 111 of the driving motor 110 from the inlet thereof towards the suction port 95a of the suction duct 95 in order to gradually reduce an air flowing area.

Also, the suction guide 145 can be horizontally formed on the basis of the rotation shaft 111 of the driving motor 110 from the inlet thereof towards the suction port 95a of the suction duct 95 in order to make an air flowing area constant.

Also, the suction guide 145 can be extendingly formed with an inclination of a certain angle on the basis of the rotation shaft 111 of the driving motor 110 from the inlet thereof towards the suction port 95a of the suction duct 95 in order to gradually reduce an air flowing area without providing the flange portion 95b having a shape of a bell mouth at the inlet thereof.

A noise absorbing member 146 for reducing noise due to an air flow is attached to an inner circumferential surface of the suction guide 145 of various shapes according to one embodiment of the present invention.

An operation of the clothes dryer according to one embodiment of the present invention will be explained as follows.

When the driving motor 110 is rotated, the drum 90 and the suction fan 101 are respectively rotated. According to this, air is sucked into the suction duct 95 through the suction port 95a thereby to upwardly flow along the suction duct 95. The upwardly flowing air is heated by the heater 98, then is introduced into the drum 90, and then is in contact with laundry inside the drum 90 thereby to contain moisture. Then, the air is exhausted outside the cabinet 80 through the exhaust duct 84.

Since the air introduced into the suction port 95a of the suction duct 95 is guided by the suction guide 145, noise due to a drastic change of a flow of air generated from the suction port 95a of the suction duct 95 is restrained and a cooling of the driving motor 110 is facilitated thereby to enhance an efficiency of the driving motor 110. Also, the air contacting the driving motor 110 absorbs heat of the driving motor 110 and thereby temperature thereof is increased. According to this, a heating value of the heater 98 is reduced thereby to enhance the entire energy efficiency.

Hereinafter, a clothes dryer according to another embodiment of the present invention will be explained.

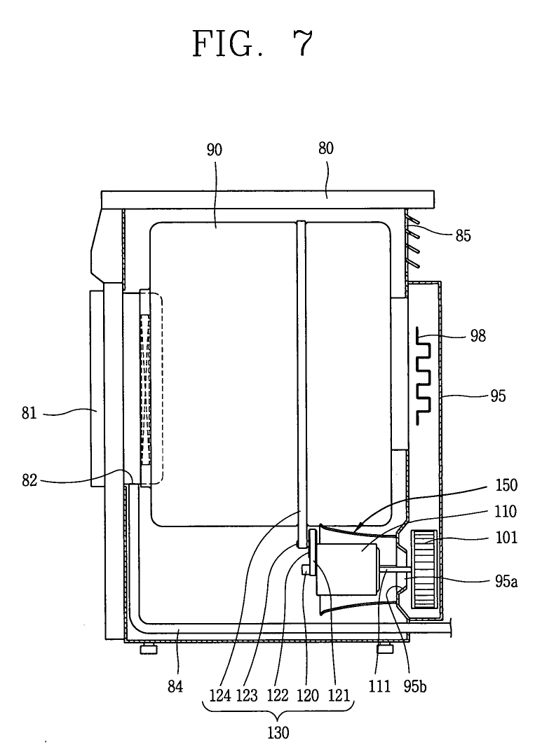

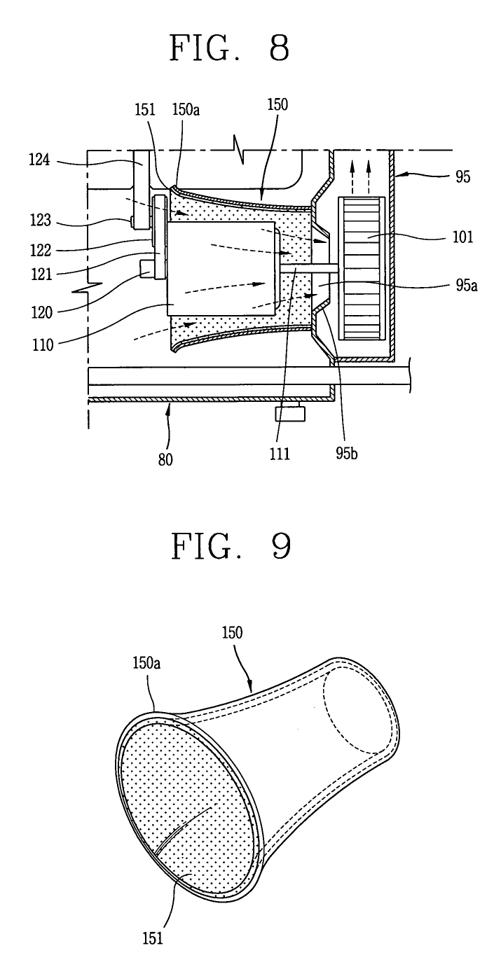

FIG. 7 is a section view showing a clothes dryer according to another embodiment of the present invention, FIG. 8 is an enlargement view of a main part of FIG. 7, and FIG. 9 is a perspective view showing a suction guide of FIG. 8.

The same reference numerals were given to the same parts as those of the clothes dryer according to one embodiment of the present invention thereby to omit its explanation.

A construction and a shape of a suction guide of a clothes dryer according to another embodiment of the present invention will be explained in more detail as follows.

As shown, a suction guide 150 of a clothes dryer according to another embodiment of the present invention is provided with a driving motor 110 inside an inner circumferential surface thereof, and the suction guide 150 is formed as a cylindrical shape to cover the circumference of the driving motor 110.

One side of the suction guide 150 is fixedly installed at an outer circumferential surface of the suction port 95a of the suction duct 95, and another end of the suction guide 150, that is, an inlet of the suction guide 150 is opened to introduce air into the suction port of the suction duct.

The suction guide 150 is preferably extended as a curved surface in order to gradually reduce an air flowing area from the inlet of the suction guide 150 towards the suction port 95a of the suction duct 95.

The inlet of the suction guide 150 is preferably provided with a flange portion 150a having a shape of a bell mouth such as an entrance of a bell along the circumference of the inlet in order to smoothly introduce air into the suction guide 150.

The shape of the suction guide 150 according to another embodiment of the present invention can be variously modified according to a design with consideration of a flow of air passing through the inside of the suction guide 150.

That is, the suction guide 150 can be extendingly formed with an inclination of a certain angle on the basis of the rotation shaft 111 of the driving motor 110 from the inlet thereof towards the suction port 95a of the suction duct 95 in order to gradually reduce an air flowing area

Also, the suction guide 150 can be horizontally formed on the basis of the rotation shaft 111 of the driving motor 110 from the inlet thereof towards the suction port 95a of the suction duct 95 in order to make an air flowing area constant.

Also, the suction guide 150 can be extendingly formed with an inclination of a certain angle on the basis of the rotation shaft 111 of the driving motor 110 from the inlet thereof towards the suction port 95a of the suction duct 95 in order to gradually reduce an air flowing area without providing the flange portion 150a having a shape of a bell mouth at the inlet thereof

A noise absorbing member 151 for reducing noise due to an air flow is attached to an inner circumferential surface of the suction guide 150 of various shapes according to another embodiment of the present invention.

An operation of the clothes dryer according to another embodiment of the present invention will be explained as follows.

When the driving motor 110 is rotated, the drum 90 and the suction fan 101 are respectively rotated. According to this, air is sucked into the suction duct 95 through the suction port 95a thereby to upwardly flow along the suction duct 95. The upwardly flowing air is heated by the heater 98, then is introduced into the drum 90, and then is in contact with laundry inside the drum 90 thereby to contain moisture. Then, the air is exhausted outside the cabinet 80 through the exhaust duct 84.

Since the air introduced into the suction port 95a of the suction duct 95 is guided by the suction guide 150, noise due to a drastic change of a flow of air generated from the suction port 95a of the suction duct 95 is restrained and a cooling of the driving motor 110 is facilitated thereby to enhance an efficiency of the driving motor 110. Also, the air contacting the driving motor 110 absorbs heat of the driving motor 110 and thereby temperature thereof is increased. According to this, a heating value of the heater 98 is reduced thereby to enhance the entire energy efficiency.

As aforementioned, according to the clothes dryer according to the present invention, the driving motor is positioned in the clothes dryer, and the suction guide for guiding sucked air is extendingly formed from the outer circumferential surface of the suction port of the suction duct in order to cover the circumference of the driving motor partially or entirely. According to this, noise due to a drastic change of a flow of air generated around the suction port can be restrained.

Also, since the air that passes through the suction guide passes through the driving motor positioned in the suction guide, the cooling of the driving motor is facilitated and thereby the efficiency of the driving motor is enhanced.

Additionally, since the air containing heat generated from the driving motor is introduced into the suction duct, a heating value of the heater for drying introduced air is reduced and thereby the entire energy efficiency is increased.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A clothes dryer comprising:
a drum rotatably installed in a cabinet;
a suction duct having a suction port for providing air inside the cabinet into the drum, and connected to the drum at one side of the drum;
a suction fan arranged in the suction duct, for sucking air inside the cabinet through the suction port; and
a suction guide extendingly installed from an outer circumferential surface of the suction port, for guiding air introduced to the suction duct.

2. The clothes dryer of claim 1, wherein a driving motor for providing a rotational force to the suction fan is arranged at an outer side of the suction port, and the driving motor is positioned inside an inner circumferential surface of the suction guide.

3. The clothes dryer of claim 2, wherein the suction guide is formed as a cylindrical shape so as to partially cover a circumference of the driving motor.

4. The clothes dryer of claim 3, wherein a flange portion having a shape of a bell mouth is formed at an inlet of the suction guide.

5. The clothes dryer of claim 3, wherein the suction guide is extendingly formed with an inclination of a certain angle on the basis of a rotation shaft of the driving motor from the inlet thereof towards the suction port of the suction duct in order to gradually reduce an air flowing area.

6. The clothes dryer of claim 3, wherein the suction guide is extendingly formed as a curved surface in order to gradually reduce an air flowing area from the inlet thereof towards the suction port of the suction duct.

7. The clothes dryer of claim 3, wherein the suction guide is horizontally formed on the basis of the rotation shaft of the driving motor from the inlet thereof towards the suction port of the suction duct in order to make an air flowing area constant.

8. The clothes dryer of claim 2, wherein the suction guide is formed as a cylindrical shape to entirely cover a circumference of the driving motor.

9. The clothes dryer of claim 9, wherein the inlet of the suction guide is formed as a shape of a bell mouth.

10. The clothes dryer of claim 8, wherein the suction guide is extendingly formed with an inclination of a certain angle on the basis of a rotation shaft of the driving motor from the inlet thereof towards the suction port of the suction duct in order to gradually reduce an air flowing area.

11. The clothes dryer of claim 8, wherein the suction guide is extendingly formed as a curved surface in order to gradually reduce an air flowing area from the inlet thereof towards the suction port of the suction duct.

12. The clothes dryer of claim 8, wherein the suction guide is horizontally formed on the basis of the rotation shaft of the driving motor from the inlet thereof towards the suction port of the suction duct in order to make an air flowing area constant.

13. The clothes dryer of claim 1, wherein a noise absorbing member for reducing noise due to an air flow is attached to an inner circumferential surface of the suction guide.
